(19) United States
(12) Patent Application Publication
(10) Pub. No.: US 2026/0077492 A1
(43) Pub. Date: Mar. 19, 2026

(54) CONTROL SYSTEM WITH MULTIPLE SIMULATORS

(71) Applicant: KABUSHIKI KAISHA YASKAWA DENKI, Kitakyushu-shi (JP)

(72) Inventors: Tsuyoshi WAKAMATSU, Fukuoka (JP); Yuki OE, Fukuoka (JP); Yoshifumi ONOYAMA, Fukuoka (JP); Motoharu MARUNO, Fukuoka (JP); Yuta ARITA, Fukuoka (JP)

(73) Assignee: KABUSHIKI KAISHA YASKAWA DENKI, Kitakyushu-shi (JP)

(21) Appl. No.: 19/401,214

(22) Filed: Nov. 25, 2025

Related U.S. Application Data
(63) Continuation of application No. PCT/JP2023/020314, filed on May 31, 2023.

(51) Int. Cl. B25J 9/16; B25J 9/00

(52) U.S. Cl. CPC B25J 9/163; B25J 9/0084

(57) ABSTRACT

A control system includes: a plurality of local controllers configured to respectively control a plurality of machines including a robot; a local simulator configured to simulate, based on a local model including a model of the robot and a model of a surrounding environment of the robot, an operation that a local controller corresponding to the robot causes the robot to perform; and a system simulator configured to simulate, based on a system model including models of the plurality of machines and a model of a surrounding environment of the plurality of machines, an operation that the plurality of local controllers cause the machines to perform.

### CROSS-REFERENCE TO RELATED APPLICATIONS

This application is a continuation application of PCT Application No. PCT/JP2023/020314, filed on May 31, 2023. The entire contents of the above listed PCT and priority applications are incorporated herein by reference.

### BACKGROUND

### Field

The present disclosure relates to a control system and control method.

### Description of the Related Art

Japanese Patent No. 6754883 discloses a system comprising a plurality of local controllers that respectively control a plurality of local devices including a robot, and a simulation unit that simulates operations that the plurality of local controllers cause the plurality of local devices to perform, based on model information of the plurality of local devices.

### SUMMARY

Disclosed herein is a control system. The control system may include: a plurality of local controllers configured to respectively control a plurality of machines including a robot; a local simulator configured to simulate, based on a local model including a model of the robot and a model of a surrounding environment of the robot, an operation that a local controller corresponding to the robot causes the robot to perform; and a system simulator configured to simulate, based on a system model including models of the plurality of machines and a model of a surrounding environment of the plurality of machines, an operation that the plurality of local controllers cause the machines to perform.

Additionally, a control method is disclosed herein. The control method may include: simulating, based on a system model including models of a plurality of machines and a model of a surrounding environment of the plurality of machines, an operation that a plurality of local controllers cause the plurality of machines to perform; simulating, based on a local model including a model of a robot included in the plurality of machines and a model of a surrounding environment of the robot, an operation that a local controller corresponding to the robot causes the robot to perform; and controlling the robot based on a simulation result from the system model and a simulation result from the local model.

### BRIEF DESCRIPTION OF THE DRAWINGS

FIG. 1 is a schematic diagram illustrating a configuration of a production system.

FIG. 2 is a schematic diagram illustrating a configuration of a robot.

FIG. 3 is a block diagram illustrating a functional configuration of a simulation device.

FIG. 4 is a block diagram illustrating a functional configuration of a host controller.

FIG. 5 is a block diagram illustrating a functional configuration of a local controller.

FIG. 6 is a block diagram illustrating a hardware configuration of a control system.

FIG. 7 is a flowchart illustrating a procedure for generating a local model.

FIG. 8 is a flowchart illustrating a procedure for correcting a system model.

FIG. 9 is a flowchart illustrating a procedure for generating a system model.

FIG. 10 is a flowchart illustrating a procedure for generating a constraint.

FIG. 11 is a flowchart illustrating a task planning procedure.

FIG. 12 is a flowchart illustrating a task command procedure.

FIG. 13 is a flowchart illustrating a procedure for correcting a local model.

FIG. 14 is a flowchart illustrating a control procedure.

FIG. 15 is a flowchart illustrating a motion path generation procedure.

FIG. 16 is a flowchart illustrating an interference check procedure.

### DETAILED DESCRIPTION

In the following description, with reference to the drawings, the same reference numbers are assigned to the same components or to similar components having the same function, and overlapping description is omitted.

### [Production System]

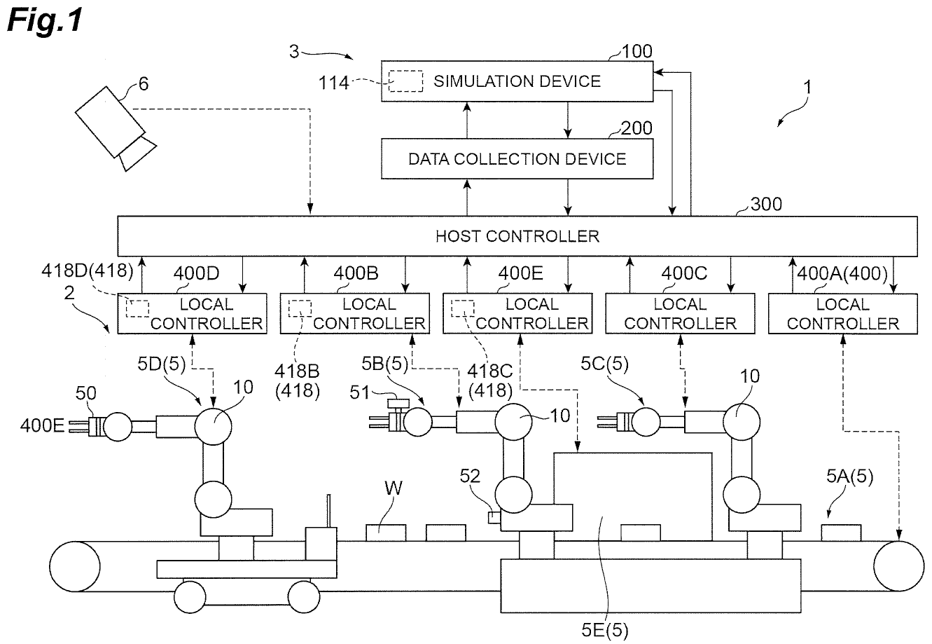

A production system 1 illustrated in FIG. 1 is a system that produces products in real space. The product may be any tangible object produced by mechanical processing and assembly of one or more parts. Real space is a space where tangible objects actually exist.

The production system 1 includes a production device 2 and a control system 3. The production device 2 executes processes on a workpiece W in real space to produce products. The workpiece W is a tangible object handled by the production device 2 to constitute at least a part of a product. For example, the workpiece W may be a part to be assembled to a product, may be an intermediate product configured by assembly of parts, or may be a finally completed product itself.

The processes for the workpiece W include a plurality of tasks. A task is a set of operations whose order is predetermined for a predetermined work objective. At least one of the plurality of tasks can be shared by two or more different processes. Although the execution order of the plurality of tasks can be changed depending on the content of the processes, the order of operations within one task cannot be changed. Examples of the plurality of tasks include carrying a base part into a work area, assembling a part to the base part, fixing the part to the base part by fastening or welding, and carrying out a product completed by assembling one or more parts to the base part from the work area.

For example, the production device 2 includes a plurality of machines 5. The plurality of machines 5 include at least a robot. The plurality of machines 5 may further include machines other than robots. Examples of machines other than robots include a transfer device that transfers the workpiece W, a device that adjusts the position and posture of the workpiece W to be worked on by the robot, and a machine tool that processes the workpiece W, but are not limited to those listed above. Any structure capable of executing a task on the workpiece W is included in the plurality of machines 5.

The plurality of tasks may include two or more tasks to be executed sequentially in series, or may include two or more tasks that can be executed simultaneously by the plurality of machines 5. Examples of tasks executed by the robot include transfer of the workpiece W, assembly of the workpiece W, fixing of the workpiece W (for example, fastening/welding), and loading/unloading of the workpiece W to/from peripheral machines such as machine tools. Examples of tasks executed by a machine tool include opening and closing of a door, chucking of the loaded workpiece W, rotation/movement of the workpiece W, tool change, arrangement/movement of a tool with respect to the workpiece W, and release of the chuck after processing.

The plurality of machines 5 illustrated in FIG. 1 include a transfer device 5A, robots 5B, 5C, 5D, and a machine tool 5E, but are not limited thereto. As long as at least a robot is included, the number and types of machines 5 can be changed in any way.

The transfer device 5A is driven by, for example, an electric motor or the like, and transfers the workpiece W. Examples of the transfer device 5A include a belt conveyor, a roller conveyor, and a carousel.

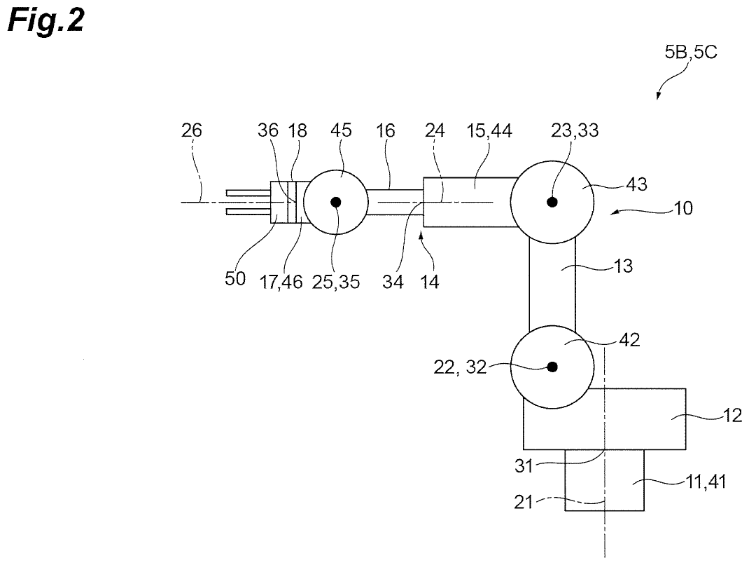

The robots 5B and 5C are vertical articulated robots, and as illustrated in FIG. 2, have an articulated arm 10 and an end effector 50. The end effector 50 acts on the workpiece W. Examples of the end effector 50 include a hand that grips the workpiece W or the like, a suction nozzle that sucks the workpiece W, a welding torch that performs welding on the workpiece W, or a screw tightening tool that performs screw tightening on the workpiece W.

The articulated arm 10 is connected to the end effector 50 and changes the position and posture of the end effector 50 by the operation of multiple joints. For example, the articulated arm 10 has a base 11, a rotation part 12, a first arm 13, a second arm 14, a third arm 17, a distal end 18, and actuators 41, 42, 43, 44, 45, 46. The base 11 is installed around the transfer device 5A. The rotation part 12 is provided on the base 11 so as to rotate around a vertical axis 21. The first arm 13 is connected to the rotation part 12 so as to swing around an axis 22 that intersects (for example, is orthogonal to) the axis 21. Intersection also includes cases where there is a skewed relationship, such as a so-called three-dimensional intersection. The second arm 14 is connected to the distal end of the first arm 13 so as to swing around an axis 23 substantially parallel to the axis 22. The second arm 14 includes the swing part 15 and a rotation part 16. The swing part 15 is connected to the distal end of the first arm 13 and extends along an axis 24 that intersects (for example, is orthogonal to) the axis 23. The rotation part 16 is connected to the distal end of the swing part 15 so as to rotate around the axis 24, and further extends along the axis 24. The third arm 17 is connected to the distal end of the rotation part 16 so as to swing around an axis 25 that intersects (for example, is orthogonal to) the axis 24. The distal end 18 is connected to the distal end of the third arm 17 so as to rotate around an axis 26 that intersects (for example, is orthogonal to) the axis 25. A work tool such as a hand, a suction nozzle, or a welding torch is attached to the distal end 18.

Thus, the articulated arm 10 has a joint 31 connecting the base 11 and the rotation part 12, a joint 32 connecting the rotation part 12 and the first arm 13, a joint 33 connecting the first arm 13 and the second arm 14, a joint 34 connecting the swing part 15 and the rotation part 16 of the second arm 14, a joint 35 connecting the rotation part 16 and the third arm 17, and a joint 36 connecting the third arm 17 and the distal end 18.

The actuators 41, 42, 43, 44, 45, 46 include, for example, electric motors and speed reducers, and drive the joints 31, 32, 33, 34, 35, 36, respectively. For example, the actuator 41 rotates the rotation part 12 around the axis 21, the actuator 42 swings the first arm 13 around the axis 22, the actuator 43 swings the second arm 14 around the axis 23, the actuator 44 rotates the rotation part 16 around the axis 24, the actuator 45 swings the third arm 17 around the axis 25, and the actuator 46 rotates the distal end 18 around the axis 26.

Note that the configuration of the articulated arm 10 can be modified. For example, the articulated arm 10 may be a 7-axis redundant robot in which one more joint is added to the above-described 6-axis configuration, or may be a so-called SCARA-type articulated robot.

Returning to FIG. 1, the robot 5D is a robot capable of autonomous traveling. For example, the robot 5D is a robot similar to the robots 5B and 5C in which the base 11 of the articulated arm 10 is capable of self-propulsion. An example of the self-propelled base 11 is an electric automated guided vehicle (AGV).

At least one of the robots 5B, 5C, 5D may have environment sensors 51, 52 at the distal end 18, the rotation part 12, or the like. The environment sensors 51, 52 are, for example, cameras or optical three-dimensional shape sensors, and acquire information on the surrounding environment of the robots 5B, 5C, 5D.

The machine tool 5E performs cutting or the like on the workpiece W loaded and unloaded by the robots 5B and 5C. Examples of the machine tool 5E include an NC lathe, an NC milling machine, or a machining center. The production device 2 may further include peripheral devices whose movable range (or area) overlaps with any of the robots 5B, 5C, 5D. For example, the movable range of the robot 5C (peripheral device) may overlap with that of the robot 5B.

The production system 1 may further include one or more environment sensors 6. Examples of the environment sensor 6 include a presence sensor provided at a position where the workpiece W can be placed, or a camera that photographs a position where the workpiece W can be placed. The environment sensor 6 is, for example, a camera or an optical three-dimensional shape sensor, and acquires state information of at least a part of the environment including the plurality of machines 5 and surrounding objects of the plurality of machines 5. The environment sensor 6 may be a presence sensor that detects whether or not the workpiece W is present at a position where the workpiece W can be placed.

The control system 3 controls the plurality of machines 5 to execute production corresponding to a production plan generated by, for example, a manufacturing execution system (MES). The control system 3 includes at least a plurality of local controllers 400 that respectively control the plurality of machines 5. In the example of FIG. 1, the plurality of local controllers 400 include a local controller 400A that controls the transfer device 5A, a local controller 400B that controls the robot 5B, a local controller 400C that controls the robot 5C, a local controller 400D that controls the robot 5D, and a local controller 400E that controls the machine tool 5E. Each of the plurality of local controllers 400 controls the corresponding machine 5 based on a predetermined local control program.

The control system 3 further includes a system simulator 114. The system simulator 114 simulates, based on a system model including models of the plurality of machines 5 and a model of a surrounding environment of the plurality of machines 5, an operation that the plurality of local controllers 400 cause the plurality of machines 5 to perform. With the system simulator 114, the combination of operations of the plurality of machines 5 and the relationship with the surrounding environment can be simulated. By simulating the combination of operations of the plurality of machines 5 and the relationship with the surrounding environment, trial and error can be repeated without operating actual machines and planning of a plurality of tasks corresponding to the production plan (for example, planning of execution order, etc.) can be performed. In addition, the simulation result can be used as a comparison target for verifying the operation result of the actual machine.

However, if all simulations for all objectives are performed by the system simulator 114, the computational load may become excessive. For example, the operation of one robot can be verified by simulation based on a model of the robot and a model of the surrounding environment of the robot. Therefore, the control system 3 further includes a local simulator 418. The local simulator 418 simulates, based on a local model including a model of the robot and a model of the surrounding environment of the robot, an operation that the local controller corresponding to the robot causes the robot to perform.

For example, in FIG. 1, the control system 3 includes local simulators 418B, 418C, 418D corresponding to the robots 5B, 5C, 5D, respectively. The local simulator 418B simulates, based on a local model including a model of the robot 5B and a model of the surrounding environment of the robot 5B, an operation that the local controller 400B causes the robot 5B to perform. The local simulator 418C simulates, based on a local model including a model of the robot 5C and a model of the surrounding environment of the robot 5C, an operation that the local controller 400C causes the robot 5C to perform. The local simulator 418D simulates, based on a local model including a model of the robot 5D and a model of the surrounding environment of the robot 5D, an operation that the local controller 400D causes the robot 5D to perform.

Thus, by including both the system simulator 114 and the local simulator 418, the system simulator 114 and the local simulator 418 can be selectively used depending on the objective, and the computational load on the entire control system 3 can be suppressed. In addition, according to the local simulator 418, which can execute simulation with a smaller computational load compared to the system simulator 114, simulation can be used for applications requiring higher-speed computation, applications requiring higher synchronization, and the like. Therefore, simulation can be utilized more beneficially.

At least one of the local controllers 400B, 400C, 400D (for example, the local controller 400B) may control the robot 5B based on a simulation result by the system simulator 114 and a simulation result by the local simulator 418B. By using both the system simulator 114 and the local simulator 418, the autonomy of the robot 5B can be enhanced, and the burden on workers such as system integrators can be reduced.

As an example, the local controller 400B may operate the robot 5B based on a simulation result by the local simulator 418B so as to perform a task assigned to the robot 5B based on a simulation result by the system simulator 114. In addition, when causing the robot 5B to perform a predetermined task, the local controller 400B may change the motion path of the robot 5B based on a simulation result by the local simulator 418B so as to satisfy a constraint set for the operation of the robot 5B based on a simulation result by the system simulator 114.

The simulation result of the system simulator 114 used for control by the local controller 400B may be generated during a time period when the local controller 400B is not controlling the robot 5B. The state in which the local controller 400B is not controlling the robot 5B is, for example, a state in which the local controller 400B is not supplying power to the robot 5B to maintain the position of the robot 5B at a target position. The simulation result of the local simulator 418 used for control by the local controller 400B may be generated while the local controller 400B is controlling the robot 5B. The state in which the local controller 400B is controlling the robot 5B is, for example, a state in which the local controller 400B is supplying power to the robot 5B to maintain the position of the robot 5B at a target position.

Similarly to the local controller 400B, the local controller 400C may operate the robot 5C based on a simulation result by the system simulator 114 and a simulation result by the local simulator 418C. The local controller 400D may operate the robot 5D based on a simulation result by the system simulator 114 and a simulation result by the local simulator 418D.

The local simulator 418B may be incorporated as a program in the storage 493 of circuitry 490 (described later) of the local controller 400B. Similarly, the local simulator 418C may be incorporated in the storage 493 of the local controller 400C, and the local simulator 418D may be incorporated in the storage 493 of the local controller 400D. By providing the local simulators 418B, 418C, 418D in the local controllers 400B, 400C, 400D, respectively, it becomes easier to use simulation for applications requiring higher-speed computation, such as generation of motion paths of the robots 5B, 5C, 5D during control of the robots 5B, 5C, 5D.

The system simulator 114 may be provided in hardware separate from the local controllers 400B, 400C, 400D. For example, the control system 3 further includes a host controller 300, a data collection device 200, and a simulation device 100, and the system simulator 114 is provided in the simulation device 100.

The host controller 300 performs synchronous communication with the plurality of local controllers 400. Synchronous communication means performing communication with the plurality of local controllers 400 once per cycle in synchronization with a synchronous frame of a constant communication cycle. The host controller 300 aggregates information from the plurality of local controllers 400 acquired by synchronous communication to update environmental information, and sequentially assigns tasks to each of the plurality of local controllers 400 based on a predetermined host control program and the environmental information. The host controller 300 may update the environmental information further based on detection results by the environment sensor 6.

The local control program stored by each of the plurality of local controllers 400 includes one or more task programs for causing the machine 5 to execute one or more tasks that can be assigned by the host controller 300. Each of the plurality of local controllers 400 causes the machine 5 to execute the assigned task by executing a task program corresponding to the task assigned by the host controller 300.

Instead of the host controller 300 assigning tasks to each of the plurality of local controllers 400, each of the plurality of local controllers 400 may select and execute one of the one or more task programs based on a comparison between execution conditions of the one or more task programs and environmental information.

The data collection device 200 performs, for example, network communication with the host controller 300, and accumulates environmental information updated by the host controller 300 in a database in time series. The simulation device 100 includes the system simulator 114 and performs network communication with the data collection device 200 and the host controller 300. The simulation device 100 simulates, using the system simulator 114, the combination of operations of the plurality of machines 5 and the relationship with the surrounding environment without operating actual machines. For example, the simulation device 100 performs planning of a plurality of tasks based on a simulation result by the system simulator 114, and provides the planning result to the host controller 300. The simulation device 100 may compare the simulation result by the system simulator 114 with the database of the data collection device 200 to detect a deviation between the operation result of the plurality of machines 5 in the simulation and the operation result of the plurality of machines 5 in real space.

Hereinafter, the configurations of the simulation device 100, the data collection device 200, the host controller 300, and the local controller 400 will be described in detail. In the description of the simulation device 100, the data collection device 200, and the host controller 300, when referring to the local controller 400 having the local simulator 418, the local controller 400B may be referred to for convenience. In addition, in the description of the local controller 400, an example configuration of the local controller 400B is described as an example of the local controller 400 having the local simulator 418.

### [Simulation Device]

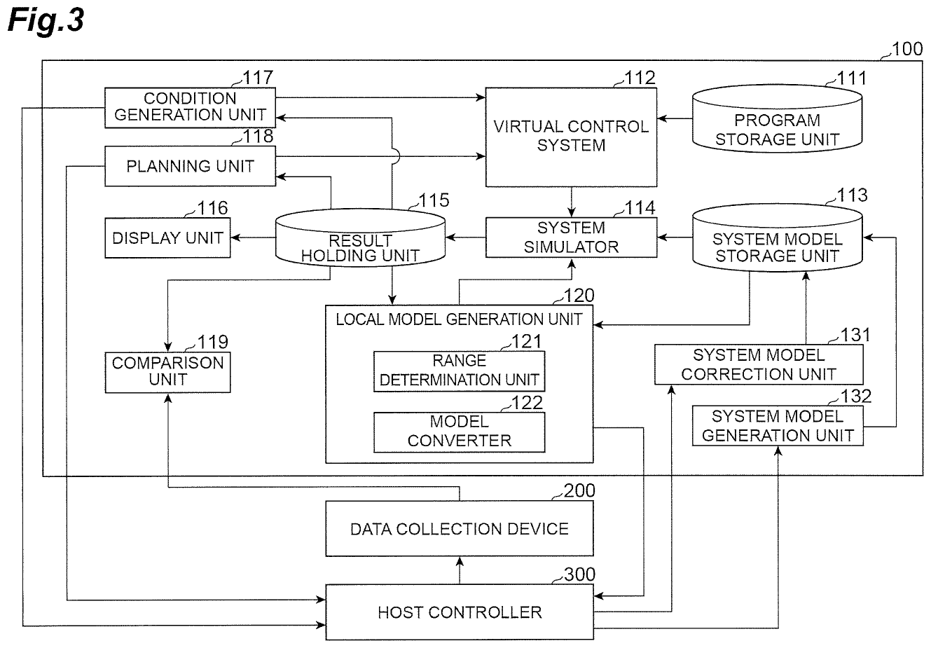

FIG. 3 is a block diagram illustrating a functional configuration of the simulation device 100. As illustrated in FIG. 3, the simulation device 100 has, as functional components (hereinafter referred to as “functional blocks”), a program storage unit 111, a virtual control system 112, a system model storage unit 113, a system simulator 114, a result holding unit 115, and a display unit 116. The program storage unit 111 stores programs (for example, the above-described host control program and local control program) executed by each of the host controller 300 and the plurality of local controllers 400 to control the plurality of machines 5. The virtual control system 112 executes the programs stored in the program storage unit 111 in the same procedure as when the host controller 300 and the plurality of local controllers 400 control the plurality of machines 5.

The system model storage unit 113 stores a system model including models of the plurality of machines 5 and a model of the surrounding environment of the plurality of machines 5. Each of the models of the plurality of machines 5 is data representing the arrangement, structure, shape, size, etc. of the corresponding machine 5 in real space. The model of the surrounding environment of the plurality of machines 5 is data representing the arrangement, structure, shape, size, etc. in real space of surrounding objects (for example, structures such as frames, sensors such as cameras, and one or more workpieces W) constituting the surrounding environment of the plurality of machines 5. The arrangement, structure, shape, and size in the system model are represented by, for example, polygon data, voxel data, sender data, or image data. The coordinate system referenced by the system model corresponds to a virtual space in which the plurality of machines 5 and the surrounding environment of the plurality of machines 5 are virtually arranged. The system model may further include information defining the relationship between the coordinate system referenced by the system model and the coordinate system referenced by at least one of the plurality of local controllers 400.

The system simulator 114 simulates operations that the plurality of local controllers 400 cause the plurality of machines 5 to perform, based on the system model stored in the system model storage unit 113 and the programs stored in the program storage unit 111. For example, the system simulator 114 operates the model of the robot 5B in virtual space by forward kinematics calculation based on the operation angles of the joints 31, 32, 33, 34, 35, 36 calculated by the virtual control system 112 and the model of the robot 5B. The same applies to the robots 5C and 5D.

The system simulator 114 operates at least one of the models of the plurality of machines 5 in virtual space each time the execution result of the program by the virtual control system 112 is updated, and causes the result holding unit 115 to store the operation history of the plurality of machines 5 in virtual space.

The display unit 116 displays on a monitor (for example, a user interface 195 described later) the virtual space in which the plurality of machines 5 are operating, based on the simulation results accumulated in time series in the result holding unit 115. For example, the display unit 116 reads out the simulation results accumulated in the result holding unit 115 in chronological order, converts the three-dimensional data included in the simulation results into two-dimensional data from a predetermined viewpoint, and displays it on the monitor. As a result, a video of the virtual space in which the plurality of machines 5 are operating is played back on the monitor.

The simulation device 100 may further have a condition generation unit 117. The condition generation unit 117 generates constraints on the operation of the robot 5B based on a simulation result by the system simulator 114. Examples of the constraints include a movable range or a non-movable range. The operation of the robot 5B may be restricted due to factors other than the link structure of the robot 5B. For example, the operation of the robot 5B may be restricted to avoid an impact on surrounding objects. Surrounding objects also include cables wired to the robot 5B. The condition generation unit 117 may generate constraints on the operation due to factors other than the link structure of the robot 5B, based on a simulation result by the system simulator 114.

Constraints on the operation due to factors other than the link structure of the robot 5B can be obtained by simulating even the influence that the operation of the robot 5B has on surrounding objects. Simulating the physical influence between two or more objects that are not integrated requires a large computational load. For this reason, it is difficult to execute the simulation in the local controller 400B with limited computational resources. Therefore, by generating constraints in advance based on a simulation result by the system simulator 114 provided in the simulation device 100 separate from the local controller 400B, the generated constraints can be used during control of the robot 5B by the local controller 400B.

The simulation device 100 may further have a planning unit 118. The planning unit 118 performs planning of a plurality of tasks based on a simulation result by the system simulator 114, and generates the planning result as the above-described host control program. For example, the planning unit 118 extracts a plurality of tasks to perform production corresponding to the production plan, sets an execution order of the plurality of tasks, and requests the virtual control system 112 to execute the plurality of tasks in the set execution order in a virtual space. The virtual control system 112 executes the programs in the program storage unit 111 so as to execute the plurality of tasks in the set execution order. The system simulator 114 operates the models of the plurality of machines 5 in virtual space based on the execution result of the programs by the virtual control system 112, and causes the result holding unit 115 to store the operation history of the models of the plurality of machines 5 in virtual space.

The planning unit 118 determines whether or not the execution result of the plurality of tasks by the plurality of machines 5 satisfies a predetermined condition, based on the operation history stored in the result holding unit 115. For example, the planning unit 118 determine whether or not the execution time of the plurality of tasks by the plurality of machines 5 is equal to or less than a predetermined threshold. The planning unit 118 may confirm whether or not the power consumption of the plurality of machines 5 for executing the plurality of tasks is equal to or less than a predetermined threshold. Thereafter, the planning unit 118 repeats changing the execution order of the plurality of tasks and causing the plurality of machines 5 to execute the plurality of tasks in virtual space in the changed execution order until the execution result of the plurality of tasks by the plurality of machines 5 satisfies the predetermined condition. The planning unit 118 generates the execution order of the plurality of tasks for which an execution result satisfying the predetermined condition was obtained, as a planning result. The operation history of the plurality of machines 5 that satisfied the predetermined condition may be held in the result holding unit 115.

The planning result by the planning unit 118 is acquired by the host controller 300 as the above-described host control program and executed. When the host controller 300 executes the host control program, the plurality of machines 5 operate in real space, and the operation history of the plurality of machines 5 in real space is accumulated in the data collection device 200.

The simulation device 100 may further have a comparison unit 119. The comparison unit 119 detects a deviation between the operation history of the plurality of machines 5 in the virtual space and the operation history of the plurality of machines 5 in the real space by comparing the operation history stored in the result holding unit 115 with the operation history stored in the data collection device 200.

The simulation device 100 may further have a local model generation unit 120. The local model generation unit 120 generates a local model based on the system model stored in the system model storage unit 113. The local model generated by the local model generation unit 120 is used for simulation by the local simulator 418. When the local controllers 400B, 400C, 400D have the local simulators 418B, 418C, 418D, respectively, the local model generation unit 120 may generate local models corresponding to each of the local simulators 418B, 418C, 418D.

The local model generation unit 120 may generate a copy of the system model as a local model, but may also generate a local model by extracting (copying a part of the system model) a part of the system model. Compared to the system model, the data size of the local model is reduced and the computational load on the local simulator is reduced, so simulation can be used for applications requiring higher-speed computation.

The local model generation unit 120 may determine a range to be extracted as a local model based on the system model. Based on the system model, the range for the local model can be extracted without excess or deficiency. For example, the local model generation unit 120 identifies, based on the system model, the movable range of the model of the robot 5B and one or more models included in the movable range of the model of the robot 5B, and determines a range to be extracted as a local model so as to include at least the model of the robot 5B and the identified one or more models. The local model generation unit 120 may identify the movable range of the model of the robot 5B and one or more models included in the movable range of the model of the robot 5B, based on a simulation result of the operation of the robot 5B by the system simulator 114.

The local model generation unit 120 may generate a local model by performing a predetermined data conversion on a copy of the system model. Even when the data format of the local model and the system model are different, the local model can be readily generated based on the system model.

An example of data conversion is conversion of data granularity. For example, the local model generation unit 120 may generate a local model by performing data conversion that lowers the data granularity on a copy of the system model. Compared to the system model, the data size of the local model is reduced and the computational load on the local simulator is reduced, so simulation can be used for applications requiring higher-speed computation.

The local model generation unit 120 may include a range determination unit 121 and a model converter 122. The range determination unit 121 determines a range to be extracted as a local model based on the system model. The model converter 122 copies (extracts) the range determined by the range determination unit 121 from the system model, and generates a local model by performing a predetermined data conversion on the copied range. Even when both the range and the data format are different between the local model and the system model, the local model can be readily generated based on the system model. In addition, since data conversion is performed on the range to be extracted, the computational load for generating the local model can be reduced compared to performing data conversion on the entire system model.

The simulation device 100 may further include a system model correction unit 131. As will be described later, when the local model is corrected in any of the local controllers 400B, 400C, 400D, the system model correction unit 131 corrects the system model based on the correction content of the local model. The system model correction unit 131 may directly acquire information on the correction content of the local model from each of the local controllers 400B, 400C, 400D, or may acquire the information from at least one of the local controllers 400B, 400C, 400D via the host controller 300.

The information on the correction content of the local model may be a corrected local model, or may be information indicating the correction content of the local model. When acquiring a corrected local model as information on the correction content of the local model, the system model correction unit 131 extracts a difference between the corrected local model and the system model, and reflects the extracted difference in the system model. Examples of the difference include a difference in at least one of the arrangement, structure, shape, and size of the model.

When acquiring information indicating the correction content of the local model, the system model correction unit 131 reflects the correction content of the local model in the system model. Examples of information indicating the correction content include information indicating the amount of change and the direction of change of at least one of the arrangement, structure, shape, and size of the model.

When the system model correction unit 131 is further provided, both the local model and the system model can be readily adapted to the actual situation. Therefore, simulation can be utilized more beneficially.

The simulation device 100 may further have a system model generation unit 132. The system model generation unit 132 newly generates a system model based on information acquired from the plurality of local controllers 400, and stores it in the system model storage unit 113. The information acquired from the plurality of local controllers 400 may include local models acquired from the local controllers 400B, 400C, 400D, or may include information on the surrounding environment acquired by sensors or the like provided in the machine 5. For example, the system model generation unit 132 generates a system model by integrating information acquired from the plurality of local controllers 400 into a single coordinate system by coordinate transformation. By aggregating information from the plurality of local controllers 400, the system model can be readily generated. For example, if each of the plurality of local controllers 400 holds information for generating a system model before a system is constructed with the plurality of local controllers 400, the system model can be readily generated by beneficially utilizing the existing information in the plurality of local controllers 400.

### [Host Controller]

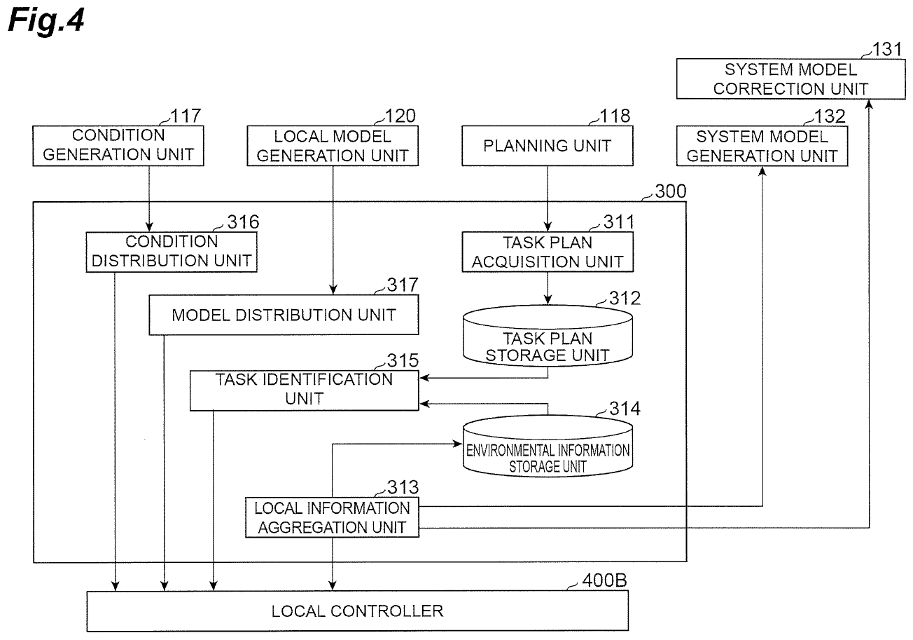

FIG. 4 is a block diagram illustrating a functional configuration of the host controller 300. As illustrated in FIG. 4, the host controller 300 has, as functional blocks, a task plan acquisition unit 311, a task plan storage unit 312, a local information aggregation unit 313, an environmental information storage unit 314, a task identification unit 315, a condition distribution unit 316, and a model distribution unit 317. The task plan acquisition unit 311 acquires the planning result by the planning unit 118, and stores the acquired planning result in the task plan storage unit 312 as a host control program. The local information aggregation unit 313 repeats acquiring information on the surrounding environment acquired by sensors or the like provided in the machine 5 from each of the plurality of local controllers 400 at the communication cycle, aggregates the information acquired in the same communication cycle to generate environmental information, and stores the environmental information in the environmental information storage unit 314.

The environmental information stored in the environmental information storage unit 314 is accumulated in time series by the data collection device 200. The environmental information storage unit 314 may be configured to store a plurality of sets of environmental information repeatedly generated by the local information aggregation unit 313 in time series. This allows for flexibility in the acquisition frequency and acquisition timing of environmental information by the data collection device 200.

The task identification unit 315 identifies a task to be executed next by one of the plurality of machines 5, based on the execution order of the plurality of tasks in the planning result stored in the task plan storage unit 312 and the environmental information stored in the environmental information storage unit 314. For example, the task identification unit 315 extracts the next task (the task to be executed next) based on the planning result stored in the task plan storage unit 312. When the task identification unit 315 determines that the robot 5B can execute the extracted task based on the environmental information stored in the environmental information storage unit 314, it identifies the extracted task as the task to be executed next by the robot 5B. The task identification unit 315 transmits an execution command for the identified task to the local controller 400B.

The condition distribution unit 316 acquires the constraint generated by the condition generation unit 117 from the condition generation unit 117 together with identification information of the robot (for example, robot 5B) to which the constraint applies, and distributes the acquired constraint to the robot identified by the identification information.

The model distribution unit 317 acquires the local model generated by the local model generation unit 120 from the local model generation unit 120 together with identification information of the robot (for example, robot 5B) to which the local model corresponds, and distributes the acquired local model to the robot identified by the identification information.

### [Local Controller]

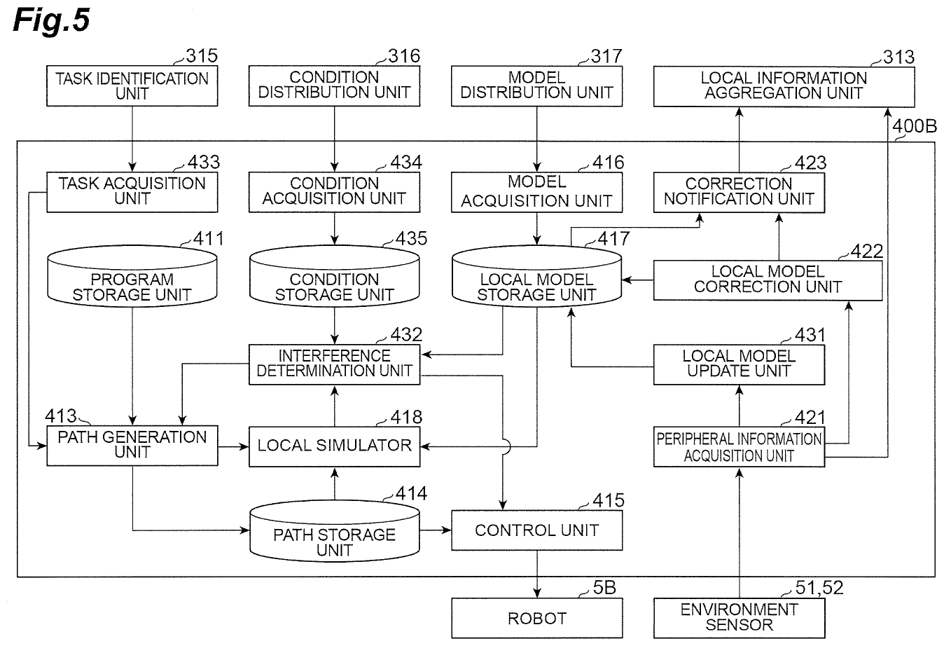

FIG. 5 is a block diagram illustrating a functional configuration of the local controller 400B. The local controller 400B includes, as functional blocks, a program storage unit 411, a path generation unit 413, a path storage unit 414, a control unit 415, a model acquisition unit 416, a local model storage unit 417, and a local simulator 418.

The program storage unit 411 stores a local control program. For example, the local control program includes one or more task programs. Each of the one or more task programs is a program that causes the robot 5B to execute a task of the production system 1. For example, each of the one or more task programs includes a plurality of operation commands in time series. Each of the plurality of operation commands includes a position designation part that defines a target position and a target posture of the distal end 18, and a speed designation part that defines a target movement speed to the target position and target posture. Each of the plurality of operation commands may further include a path type designation part that defines a type of motion path that the distal end 18 follows to the target position and target posture.

The position designation part may define the target position and target posture of the distal end 18 by target angles of each of the joints 31, 32, 33, 34, 35, 36. The speed designation part may define the target speed by target rotational speeds of each of the joints 31, 32, 33, 34, 35, 36.

Examples of types of motion paths include the following.
i) Linear path: A motion path that linearly connects the position and posture at the start of movement by the operation command (hereinafter referred to as “movement start position and movement start posture”) to the target position and target posture.
ii) S-shaped path: A motion path that connects the movement start position and movement start posture to the target position and target posture with an S-shaped curve.
iii) Constant joint velocity path: A motion path that is followed when the joints 31, 32, 33, 34, 35, 36 are rotated at a constant speed from the movement start position and movement start posture to the target position and target posture.

The path generation unit 413 sequentially reads out the plurality of operation commands of the task program stored in the program storage unit 411, and generates a motion path according to the path type specified by the path type designation part described above. The motion path includes a target movement speed along the motion path.

The control unit 415 controls the motion of the robot 5B. Controlling the motion of the robot 5B includes operating the robot 5B along the generated motion path and holding the robot 5B at a fixed position.

In order to control the motion of the robot 5B, the control unit 415 repeats control of the position of the robot 5B at a predetermined control cycle. In each control cycle, the control unit 415 calculates a target position and target posture in the current control cycle (hereinafter collectively referred to as “cycle target position”) based on the motion path stored in the path storage unit 414, calculates target angles of the joints 31, 32, 33, 34, 35, 36 corresponding to the cycle target position (hereinafter referred to as “cycle target angles”), and supplies drive power to the actuators 41, 42, 43, 44, 45, 46 so as to reduce the deviation between the cycle target angles and the current angles of the joints 31, 32, 33, 34, 35, 36. Note that when the position designation part defines the target position and target posture by target angles of each of the joints 31, 32, 33, 34, 35, 36 in the operation command, the control unit 415 may calculate the cycle target angles based on the target angles of the position designation part without performing inverse kinematics calculation.

The control unit 415 holds the robot 5B at a fixed position when there is no generated motion path in the path storage unit 414. The control unit 415 repeats the above-described control of the position of the robot 5B at the control cycle with the target position and target posture set to constant values. Thus, when the control of the position of the robot 5B is continued with the target position and target posture set to constant values, even if the robot 5B is stopped, the control of the robot 5B is continued.

The local controller 400 further has a local model storage unit 417 and a local simulator 418. The local model storage unit 417 stores a local model including a model of the robot 5B and a model of the surrounding environment of the robot 5B. The model of the robot 5B is data representing the arrangement, structure, shape, size, etc. of the robot 5B in real space. The model of the surrounding environment of the robot 5B is data representing the arrangement, structure, shape, size, etc. in real space of objects constituting the surrounding environment of the robot 5B (for example, other machines 5, structures such as frames, and one or more workpieces W). The coordinate system referenced by the local model corresponds to a virtual space in which the robot 5B and the surrounding environment of the robot 5B are virtually arranged.

The local simulator 418 simulates an operation that the local controller 400B causes the robot 5B to perform, based on the local model stored in the local model storage unit 417. For example, the local simulator 418 simulates the operation of the robot 5B along the motion path stored in the path storage unit 414. For example, the local simulator 418 operates the model of the robot 5B in virtual space so that the distal end 18 moves along the motion path stored in the path storage unit 414.

The local controller 400 may further have a model acquisition unit 416. The model acquisition unit 416 acquires the local model generated by the local model generation unit 120 of the simulation device 100 for the robot 5B, and stores the acquired local model in the local model storage unit 417. The model acquisition unit 416 may acquire the local model from the model distribution unit 317 of the host controller 300.

The local controller 400 may further have a peripheral information acquisition unit 421, a local model correction unit 422, and a correction notification unit 423. The peripheral information acquisition unit 421 acquires, for example, state information of the surrounding environment of the robot 5B from the environment sensors 51, 52. When the environment sensors 51, 52 are cameras, the peripheral information acquisition unit 421 acquires state information of the surrounding environment by image processing from images acquired by the environment sensors 51, 52. The information acquired by the peripheral information acquisition unit 421 is transmitted to the local information aggregation unit 313 of the host controller 300, and is also used for generating the above-described environmental information. The peripheral information acquisition unit 421 may acquire state information of the surrounding environment based on the state of the robot 5B, regardless of the environment sensors 51, 52. For example, the peripheral information acquisition unit 421 may calculate the position of the distal end 18 of the robot 5B based on the state of the robot 5B, and acquire position information of a surrounding object in contact with the distal end 18 based on the calculated position of the distal end 18.

The local model correction unit 422 corrects the local model stored in the local model storage unit 417 based on the state information of the robot 5B and the state information of the surrounding environment of the robot 5B acquired by the peripheral information acquisition unit 421. For example, the local model correction unit 422 extracts a difference between the space represented by the state information of the robot 5B and the state information of the surrounding environment of the robot 5B acquired by the peripheral information acquisition unit 421 and the space represented by the local model, and reflects the extracted difference in the local model. Examples of the difference include a difference in at least one of the arrangement, structure, shape, and size of the model. The difference that the local model correction unit 422 reflects in the local model is limited to differences in arrangement, structure, shape, and size that are substantially invariant among the arrangement, structure, shape, and size of the model, and does not include things that can change over time, such as the arrangement of the workpiece W and the arrangement of movable parts of other machines 5. Since the arrangement of the base 11 of the robot 5C is substantially invariant, the difference in the arrangement of the base 11 of the robot 5C can be reflected in the local model by the local model correction unit 422.

The correction notification unit 423 transmits information on the correction content of the local model made by the local model correction unit 422 to the system model correction unit 131. The correction notification unit 423 may transmit information on the correction content of the local model to the system model correction unit 131 via the local information aggregation unit 313 of the host controller 300. The correction notification unit 423 may transmit the corrected local model as information on the correction content of the local model, or may transmit information indicating the correction content of the local model. Examples of information indicating the correction content include information indicating the amount of change and the direction of change of at least one of the arrangement, structure, shape, and size of the model.

The system model correction unit 131 that has received the correction content of the local model from the correction notification unit 423 corrects the system model based on the correction content of the local model, as described above.

The system model can also be updated by the correction content of the local model in the local controllers 400C, 400D. Therefore, the peripheral information acquisition unit 421 may further acquire information on the surrounding environment of the robot 5B from the system model updated by the correction content of each local model. The local model correction unit 422 may correct the local model stored in the local model storage unit 417 based on the state information of the surrounding environment of the robot 5B further acquired by the peripheral information acquisition unit 421 from the system model. As a result, the local models of the plurality of local controllers 400 are complementarily corrected, so the reliability of each local model can be improved.

The local controller 400 may further include a local model update unit 431 and an interference determination unit 432. The local model update unit 431 updates the local model based on a change in the surrounding environment of the robot 5B. When the local model has been corrected by the local model correction unit 422, the local model update unit 431 updates the corrected local model based on a change in the surrounding environment of the robot 5B.

For example, the local model update unit 431 extracts a difference between the space represented by the state information of the robot 5B and the state information of the surrounding environment of the robot 5B acquired by the peripheral information acquisition unit 421 and the space represented by the local model, and reflects the extracted difference in the local model. Examples of the difference include a difference in at least one of the arrangement, structure, shape, and size of the model. The difference that the local model update unit 431 reflects in the local model is a difference in arrangement, structure, shape, and size that can change over time among the arrangement, structure, shape, and size of the model. For example, differences due to temporal changes such as the arrangement of the workpiece W and the arrangement of movable parts of other machines 5 are reflected in the local model by the local model update unit 431.

The interference determination unit 432 determines whether or not the motion path of the robot 5B interferes with surrounding objects of the robot 5B, based on a simulation result by the local simulator 418 based on the local model updated by the local model update unit 431. For example, each time the local model is updated by the local model update unit 431, the interference determination unit 432 operates the model of the robot 5B in virtual space along the motion path stored in the path storage unit 414, and determines whether or not the model of the robot 5B interferes with the model of surrounding objects of the robot 5B. Interference means, for example, that the model of the robot 5B and the model of surrounding objects of the robot 5B partially overlap in virtual space. The robot 5B can be operated while verifying in real time whether or not a predetermined motion path of the robot 5B can adapt to changes in the surrounding environment.

The interference determination unit 432 may cause the local simulator 418 to execute simulation while the control of the robot 5B by the control unit 415 is continuing, and determine whether or not the motion path of the robot 5B interferes with surrounding objects of the robot 5B. For example, while the control unit 415 is operating the robot 5B along the motion path stored in the path storage unit 414, the interference determination unit 432 may cause the local simulator 418 to execute simulation for at least a section of the motion path in which the robot 5B has not yet operated, and determine whether or not the motion path of the robot 5B interferes with surrounding objects of the robot 5B. The interference determination unit 432 may cause the local simulator 418 to execute simulation based on a feedback value acquired from the robot 5B, and determine whether or not the actual motion path of the robot 5B interferes with surrounding objects of the robot 5B.

When the interference determination unit 432 determines that the motion path of the robot 5B interferes with surrounding objects of the robot 5B, the control unit 415 may stop the operation of the robot 5B along the motion path. For example, the control unit 415 stops updating the cycle target position along the motion path, and continues control of the robot 5B while keeping the subsequent cycle target position constant. When it is determined that the motion path of the robot 5B interferes with surrounding objects of the robot 5B, the control unit 415 may stop control of the robot 5B. Thus, according to a configuration in which the control unit 415 stops the operation of the robot 5B when the interference determination unit 432 determines that the robot 5B interferes with surrounding objects, the operation of the robot 5B along the motion path is continued when the interference determination unit 432 determines that the robot 5B does not interfere with surrounding objects.

The control unit 415 may not stop the robot 5B when it is determined that the motion path of the robot 5B interferes with surrounding objects of the robot 5B. The local controller 400B may notify, by displaying on a monitor or the like, an operator that it has been determined that the motion path of the robot 5B interferes with surrounding objects of the robot 5B.

The path generation unit 413 may generate a motion path of the robot 5B based on a simulation result by the local simulator 418 while control of the plurality of machines 5 by the plurality of local controllers 400 is at least partially ongoing. For example, the path generation unit 413 may generate a motion path of the robot 5B based on a simulation result by the local simulator 418 while control of the robot 5B by the control unit 415 is continuing. For example, while the control unit 415 is operating the robot 5B along the motion path stored in the path storage unit 414, the path generation unit 413 may generate a motion path following the motion path stored in the path storage unit 414, based on a simulation result by the local simulator 418.

As an example, the types of motion paths that can be designated by the path type designation part of the operation command may further include the following in addition to the above-described “linear path,” “S-shaped path,” and “constant joint velocity path.” iv) Auto path: A path generated so as not to interfere with surrounding objects from the movement start position and movement start posture to the target position and target posture.

Hereinafter, an operation command whose path designation part is “auto path” is referred to as an “auto path command.” When the path generation unit 413 reads out an auto path command, while the control unit 415 is operating the robot 5B based on the operation command read out in advance, it repeats the following processing to generate a motion path from the movement start position and movement start posture to the target position and target posture by the auto path command. For example, the path generation unit 413 first provisionally generates a motion path from the movement start position and movement start posture to the target position and target posture, and requests the local simulator 418 to perform simulation with the provisionally generated motion path. The local simulator 418 operates the model of the robot 5B in virtual space along the provisionally generated motion path, and the interference determination unit 432 determines whether or not the provisionally generated motion path of the robot 5B interferes with surrounding objects of the robot 5B. When it is determined that the provisionally generated motion path of the robot 5B interferes with surrounding objects of the robot 5B, the path generation unit 413 corrects the motion path by adding a waypoint to the provisionally generated motion path that can avoid interference with surrounding objects. Thereafter, the path generation unit 413 repeats correcting the motion path based on the simulation result by the local simulator 418 until it is determined that the corrected motion path does not interfere with surrounding objects of the robot 5B. The path generation unit 413 generates the corrected motion path at the time when it is determined that it does not interfere with surrounding objects of the robot 5B as a motion path corresponding to the auto path, and stores it in the path storage unit 414. With the local simulator 418, simulation can be used during control.

For such simulation during control, it is beneficial that the local model storage unit 417 and the local simulator 418 are provided in the local controller 400B together with the program storage unit 411, the path generation unit 413, the path storage unit 414, and the control unit 415. An example of the local model storage unit 417 and the local simulator 418 being provided in the local controller 400B together with the program storage unit 411, the path generation unit 413, the path storage unit 414, and the control unit 415 is that the local model storage unit 417, the local simulator 418, the program storage unit 411, the path generation unit 413, the path storage unit 414, and the control unit 415 are provided in an arithmetic circuit of the production system 1 integrated by a system bus.

As described above, the local controller 400B may control the robot 5B based on a simulation result by the system simulator 114 and a simulation result by the local simulator 418. For example, the local control program stored in the program storage unit 411 includes a plurality of task programs, and the local controller 400B may further have a task acquisition unit 433. The task acquisition unit 433 acquires the task execution command transmitted by the task identification unit 315. The local controller 400B controls the robot 5B to execute the task corresponding to the execution command.

As described above, the execution command is generated based on the planning result stored in the task plan storage unit 312, and the planning result stored in the task plan storage unit 312 is generated based on a simulation result by the system simulator 114. Therefore, controlling the robot 5B to execute the task corresponding to the execution command corresponds to controlling the robot 5B based on a simulation result by the system simulator 114.

The local controller 400B may control the robot 5B to execute the task corresponding to the execution command based on a simulation result by the local simulator 418. The robot 5B is controlled based on a simulation result by the system simulator 114 and a simulation result by the local simulator 418.

For example, when the interference determination unit 432 determines that the motion path of the robot 5B for executing the task corresponding to the execution command interferes with surrounding objects of the robot 5B, the robot 5B may stop the operation of the robot 5B along the motion path, and when the interference determination unit 432 determines that the motion path does not interfere with surrounding objects, the operation of the robot 5B along the motion path may be continued. As described above, whether or not the motion path of the robot 5B interferes with surrounding objects of the robot 5B is determined based on a simulation result by the local simulator 418. Therefore, the robot 5B is controlled based on a simulation result by the system simulator 114 and a simulation result by the local simulator 418.

The path generation unit 413 may sequentially read out a plurality of operation commands of a task program corresponding to the execution command among the plurality of task programs stored in the program storage unit 411, and when an auto path command is read out, generate a motion path corresponding to the auto path based on a simulation result by the local simulator 418, and store it in the path storage unit 414. Thereafter, the control unit 415 operates the robot 5B along the motion path corresponding to the auto path. The robot 5B is controlled based on a simulation result by the system simulator 114 and a simulation result by the local simulator 418.

The local controller 400 may further have a condition acquisition unit 434 and a condition storage unit 435. The condition acquisition unit 434 acquires the constraint generated by the condition generation unit 117 and stores the constraint in the condition storage unit 435. The condition acquisition unit 434 may acquire the constraint from the condition distribution unit 316 of the host controller 300.

The local controller 400B may control the robot 5B based on the constraint stored in the condition storage unit 435 and a simulation result by the local simulator 418. As described above, the constraint is generated based on a simulation result by the system simulator 114. Therefore, controlling the robot 5B based on the constraint and a simulation result by the local simulator 418 corresponds to controlling the robot 5B based on a simulation result by the system simulator 114 and a simulation result by the local simulator 418.

For example, when an auto path command is read out, the path generation unit 413 may generate a motion path corresponding to the auto path so as to satisfy the constraint, based on a simulation result by the local simulator 418.

Although the configuration of the local controller 400B has been described above as an example of the local controller 400 having the local simulator 418, the configurations of the local controllers 400C, 400D having the local simulator 418 are described by replacing “B” with “C” or “D” in the description of the local controller 400B.

### [Hardware Configuration]

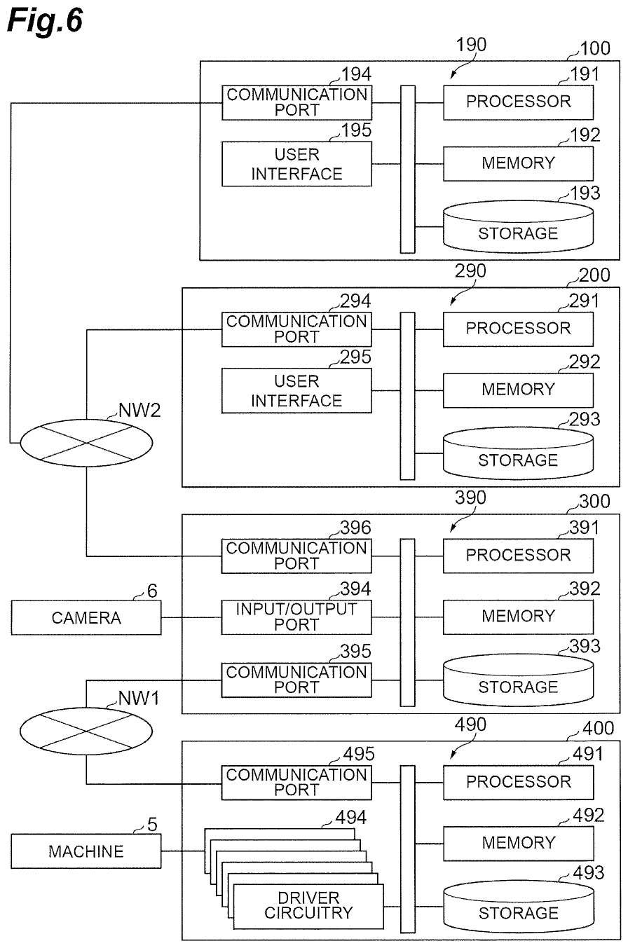

FIG. 6 is a block diagram illustrating a hardware configuration of the control system 3. As illustrated in FIG. 6, the local controller 400 has circuitry 490. The circuitry 490 has a processor 491, a memory 492, a storage 493, driver circuitry 494, and a communication port 495. The storage 493 is configured by one or more non-volatile memory devices such as flash memory or a hard disk. The storage 493 stores a program for causing the local controller 400 to execute control of the machine 5, and a local simulation program for implementing the local simulator 418 in the local controller 400. For example, the storage 493 stores a program for causing the local controller 400 to configure the above-described functional blocks.

The memory 492 is configured by one or more volatile memory devices such as random-access memory. The memory 492 temporarily stores programs loaded from the storage 493. The processor 491 is configured by one or more arithmetic devices such as a CPU (Central Processing Unit) or a GPU (Graphics Processing Unit). The processor 491 causes the local controller 400 to configure the above-described functional blocks by executing the programs loaded in the memory 492. The calculation results by the processor 491 are temporarily stored in the memory 492.

The driver circuitry 494 operates the articulated arm 10 in response to a request from the processor 491. The communication port 495 communicates with the host controller 300 via the communication network NW1 for control in response to a request from the processor 491.

The host controller 300 has circuitry 390. The circuitry 390 has a processor 391, a memory 392, a storage 393, an input/output port 394, a communication port 395, and a communication port 396. The storage 393 is configured by one or more non-volatile memory devices such as flash memory or a hard disk. The storage 393 stores a program for causing the host controller 300 to execute updating of environmental information and assignment of tasks to the plurality of local controllers 400. For example, the storage 393 stores a program for causing the host controller 300 to configure the above-described functional blocks.

The memory 392 is configured by one or more volatile memory devices such as random-access memory. The memory 392 temporarily stores programs loaded from the storage 393. The processor 391 is configured by one or more arithmetic devices such as a CPU or a GPU. The processor 391 causes the host controller 300 to configure the above-described functional blocks by executing the programs loaded in the memory 392. The calculation results by the processor 391 are temporarily stored in the memory 392.

The input/output port 394 exchanges information with the environment sensor 6 in response to a request from the processor 391. The communication port 395 communicates with the local controller 400 via the communication network NW1 in response to a request from the processor 391. The communication port 396 communicates with the simulation device 100 and the data collection device 200 via the communication network NW2 in response to a request from the processor 391. The communication network NW2 may be a network different from the communication network NW1, or may be the same network as the communication network NW1.

The data collection device 200 has circuitry 290. The circuitry 290 has a processor 291, a memory 292, a storage 293, a communication port 294, and a user interface 295. The storage 293 is configured by one or more non-volatile memory devices such as flash memory or a hard disk. The storage 293 stores a program for causing the data collection device 200 to execute accumulation of environmental information in time series.

The memory 292 is configured by one or more volatile memory devices such as random-access memory. The memory 292 temporarily stores programs loaded from the storage 293. The processor 291 is configured by one or more arithmetic devices such as a CPU or a GPU. The processor 291 executes the programs loaded in the memory 292. The calculation results by the processor 291 are temporarily stored in the memory 292.

The communication port 294 communicates with the simulation device 100 and the host controller 300 via the communication network NW2 in response to a request from the processor 291. The user interface 295 inputs and outputs information to and from an operator in response to a request from the processor 291. For example, the user interface 295 has a display device such as a liquid crystal monitor or an organic EL (Electro-Luminescence) monitor, and an input device such as a keyboard or a mouse. The input device may be integrated with the display device as a touch panel.

The simulation device 100 has circuitry 190. The circuitry 190 has a processor 191, a memory 192, a storage 193, a communication port 194, and a user interface 195. The storage 193 is configured by one or more non-volatile memory devices such as flash memory or a hard disk. The storage 193 stores a system simulation program for implementing the system model storage unit 113 in the simulation device 100. For example, the storage 193 stores a program for causing the simulation device 100 to configure the above-described functional blocks.

The memory 192 is configured by one or more volatile memory devices such as random-access memory. The memory 192 temporarily stores programs loaded from the storage 193. The processor 191 is configured by one or more arithmetic devices such as a CPU or a GPU. The processor 191 causes the simulation device 100 to configure the above-described functional blocks by executing the programs loaded in the memory 192. The calculation results by the processor 191 are temporarily stored in the memory 192.

The communication port 194 communicates with the data collection device 200 and the host controller 300 via the communication network NW2 in response to a request from the processor 191. The user interface 195 inputs and outputs information to and from an operator in response to a request from the processor 191. For example, the user interface 195 has a display device such as a liquid crystal monitor or an organic EL (Electro-Luminescence) monitor, and an input device such as a keyboard or a mouse. The input device may be integrated with the display device as a touch panel.

The above hardware configuration is merely an example and can be modified. For example, the data collection device 200 may be incorporated in the simulation device 100. In addition, the simulation device 100 and the data collection device 200 may be incorporated in the host controller 300.

### [Control Procedure]

As an example of a control method, an example control procedure executed by the control system 3 is described. This control procedure includes simulating, based on a system model, an operation that the plurality of local controllers 400 cause the plurality of machines 5 to perform, simulating, based on a local model including a model of the robot 5B and a model of the surrounding environment of the robot 5B, an operation that the local controller 400B causes the robot 5B to perform, and controlling the robot 5B based on a simulation result from the system model and a simulation result from the local model.

An example control procedure described below may include at least one of a local model generation procedure, a system model correction procedure, a system model generation procedure, a constraint generation procedure, and a task planning procedure executed by the simulation device 100; a task command procedure executed by the host controller 300; and a local model correction procedure, a control procedure, a motion path generation procedure, and an interference check procedure executed by the local controller 400. Each example procedure is described below.

### (Local Model Generation Procedure)

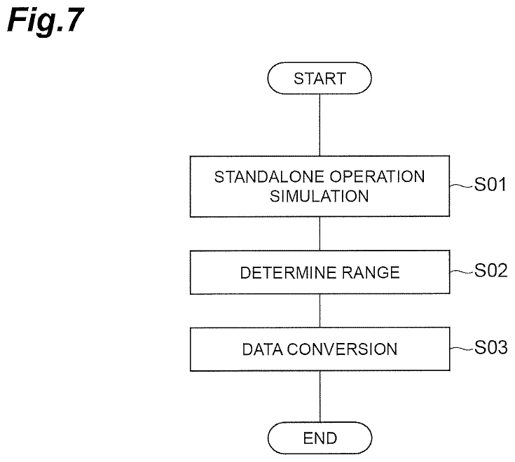

As illustrated in FIG. 7, the simulation device 100 executes operations S01, S02, and S03. In operation S01, the system simulator 114 simulates the operation of the robot 5B based on the system model in response to a request from the range determination unit 121. In operation S02, the range determination unit 121 determines a range to be extracted as a local model based on the simulation result of the operation of the robot 5B by the system simulator 114. In operation S03, the model converter 122 copies (extracts) the range determined by the range determination unit 121 from the system model, and generates a local model by performing a predetermined data conversion on the copied range. This completes the local model generation procedure. If the range to be extracted can be determined based on the system model without performing simulation by the system simulator 114, operation S01 can be omitted.

### (System Model Correction Procedure)

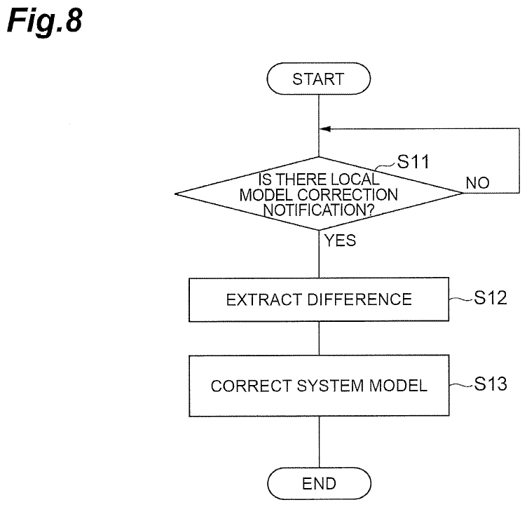

As illustrated in FIG. 8, the simulation device 100 executes operations S11, S12, and S13. In operation S11, the system model correction unit 131 waits for information on the correction content of the local model to be transmitted from the local controller 400B. In operation S12, the system model correction unit 131 extracts a difference between the corrected local model and the system model. In operation S13, the system model correction unit 131 reflects the extracted difference in the system model. This completes the system model correction procedure.

### (System Model Generation Procedure)

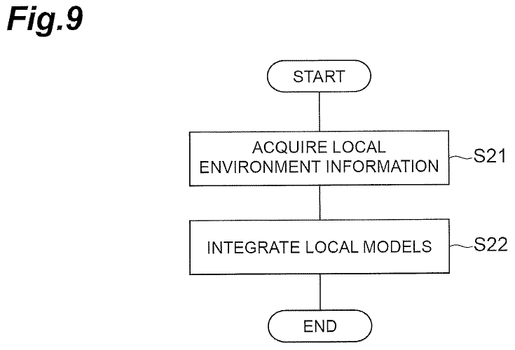

The system model generation procedure illustrated in FIG. 9 is executed when the plurality of local controllers 400 hold information for generating a system model before the system model is generated. For example, the simulation device 100 executes operations S21 and S22. In operation S21, the system model generation unit 132 acquires state information of the machine 5 and state information of the surrounding environment of the machine 5 from each of the plurality of local controllers 400. When at least one of the local controllers 400B, 400C, 400D already holds a local model prior to the system model, the system model generation unit 132 may further acquire the local model from at least one of the local controller 400B and the local controllers 400C, 400D. In operation S22, the system model generation unit 132 generates a system model by integrating the information acquired from the plurality of local controllers 400 into a single coordinate system by coordinate transformation. This completes the system model generation procedure.

### (Constraint Generation Procedure)

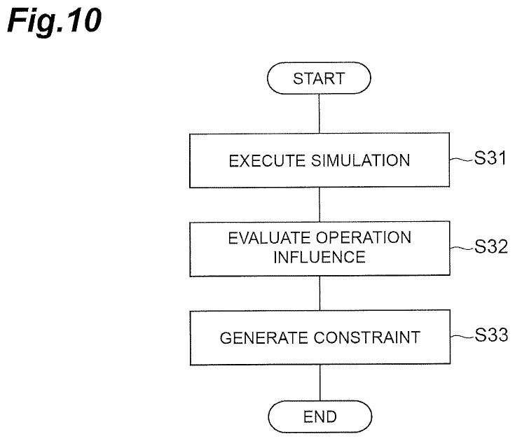

The constraint generation procedure illustrated in FIG. 10 is executed when requested by an operator through input to the user interface 195. For example, the simulation device 100 executes operations S31, S32, and S33. In operation S31, in response to a request from the condition generation unit 117, the system simulator 114 simulates the operation of the robot 5B based on the system model. In operation S32, the condition generation unit 117 evaluates the influence that the operation of the model of the robot 5B in virtual space exerts on surrounding objects. In operation S33, the condition generation unit 117 generates a constraint on the operation of the robot 5B based on the evaluation result of the influence on surrounding objects. This completes the constraint generation procedure.

### (Task Planning Procedure)

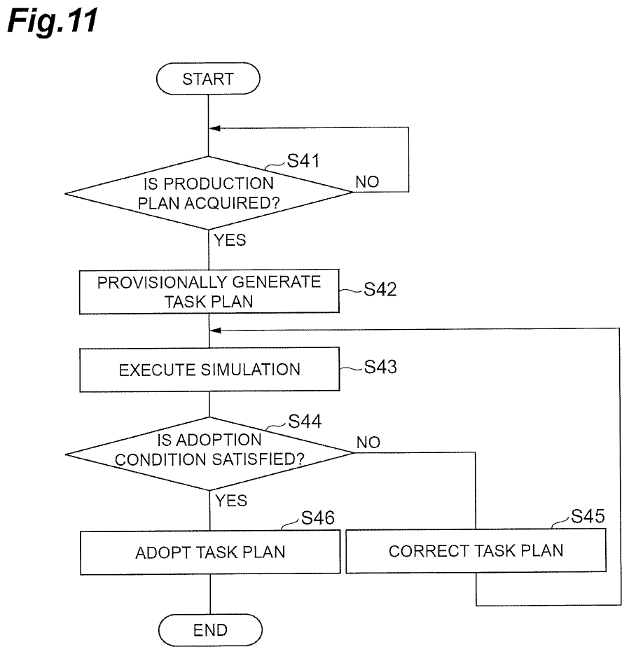

As illustrated in FIG. 11, the simulation device 100 executes operations S41 and S42. In operation S41, the planning unit 118 waits for acquisition of a production plan from the MES or the like. In operation S42, the planning unit 118 provisionally generates a task plan corresponding to the production plan. For example, the planning unit 118 extracts a plurality of tasks to perform production corresponding to the production plan, and provisionally sets an execution order of the plurality of tasks.

Next, the simulation device 100 executes operation S43. In operation S43, the planning unit 118 requests the virtual control system 112 to execute the plurality of tasks in virtual space in the provisionally set execution order. The virtual control system 112 executes the programs in the program storage unit 111 so as to execute the plurality of tasks in the provisionally set execution order. The system simulator 114 operates the models of the plurality of machines 5 in virtual space based on the execution result of the programs by the virtual control system 112, and causes the result holding unit 115 to store the operation history of the models of the plurality of machines 5 in virtual space.

Next, the simulation device 100 executes operation S44. In operation S44, the planning unit 118 confirms whether or not the execution result of the plurality of tasks by the plurality of machines 5 satisfies a predetermined adoption condition, based on the operation history stored in the result holding unit 115. In operation S44, when it is determined that the execution result of the plurality of tasks does not satisfy the adoption condition, the simulation device 100 executes operation S45. In operation S45, the planning unit 118 corrects the provisionally set execution order. Thereafter, the simulation device 100 returns the processing to operation S43. Thereafter, causing the plurality of machines 5 to execute the plurality of tasks in virtual space in the corrected execution order is repeated until the execution result of the plurality of tasks satisfies the adoption condition.

In operation S44, when it is determined that the execution result of the plurality of tasks satisfies the adoption condition, the simulation device 100 executes operation S46. In operation S46, the planning unit 118 generates the execution order of the plurality of tasks for which an execution result satisfying the adoption condition was obtained, as a planning result. This completes the task planning procedure.

### (Task Command Procedure)

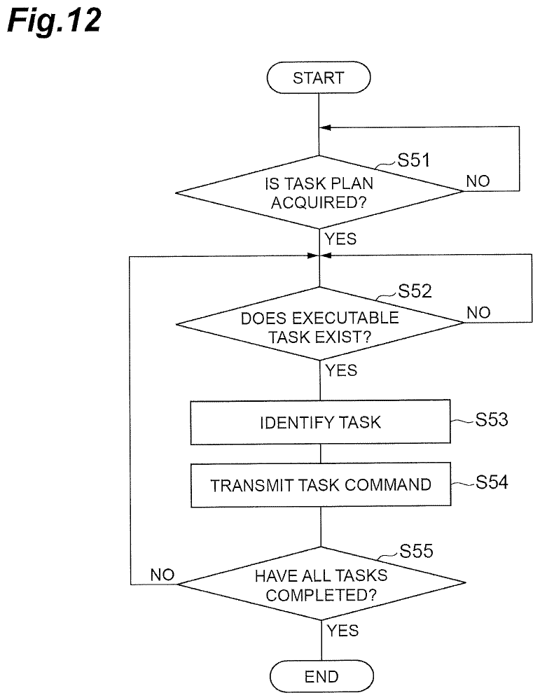

As illustrated in FIG. 12, the host controller 300 executes operations S51, S52, S53, and S54. In operation S51, the task identification unit 315 waits for the task plan acquisition unit 311 to acquire the planning result by the planning unit 118 and store it in the task plan storage unit 312. In operation S52, the task identification unit 315 waits for the next task to become executable by one of the plurality of machines 5, based on the environmental information in the environmental information storage unit 314 updated at the communication cycle by the local information aggregation unit 313 and the planning result stored in the task plan storage unit 312. Hereinafter, the machine 5 that has become capable of executing the next task is referred to as a candidate machine 5. In operation S53, the task identification unit 315 identifies the “next task” as the task to be executed next by the candidate machine 5. In operation S54, the task identification unit 315 transmits an execution command for the identified task to the local controller 400 of the candidate machine 5.

Next, the host controller 300 executes operation S55. In operation S55, the task identification unit 315 confirms whether or not execution commands for all tasks included in the planning result by the planning unit 118 have been transmitted. In operation S55, when it is determined that tasks for which execution commands have not been transmitted remain, the host controller 300 returns the processing to operation S52. In operation S55, when it is determined that execution commands for all tasks have been transmitted, the host controller 300 completes the task command procedure.

### (Local Model Correction Procedure)

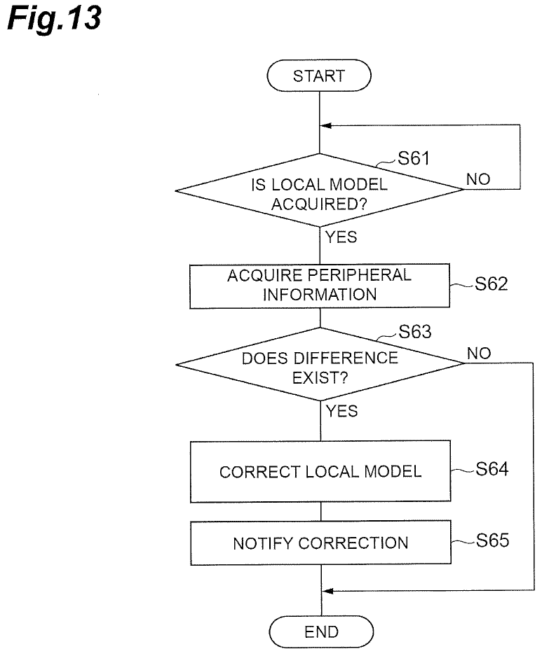

As illustrated in FIG. 13, the local controller 400 executes operations S61, S62, and S63. In operation S61, the local model correction unit 422 waits for the model acquisition unit 416 to acquire a local model and store it in the local model storage unit 417. In operation S62, the local model correction unit 422 causes the peripheral information acquisition unit 421 to acquire state information of the surrounding environment of the robot 5B. In operation S63, the local model correction unit 422 confirms whether or not there is a difference between the space represented by the state information of the robot 5B and the state information of the surrounding environment of the robot 5B acquired by the peripheral information acquisition unit 421 and the space represented by the local model.

In operation S63, when it is determined that there is a difference, the local controller 400 executes operations S64 and S65. In operation S64, the local model correction unit 422 reflects the difference in the local model stored in the local model storage unit 417. In operation S65, the correction notification unit 423 transmits information on the correction content of the local model by the local model correction unit 422 to the system model correction unit 131. This completes the local model correction procedure. In operation S63, when it is determined that there is no difference, the local controller 400 completes the local model correction procedure without executing operations S64 and S65.

### (Control Procedure)

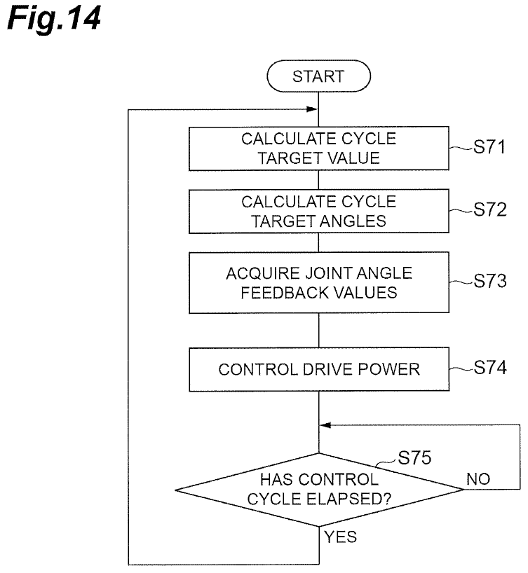

As illustrated in FIG. 14, the local controller 400B executes operations S71, S72, S73, S74, and S75. In operation S71, the control unit 415 calculates the cycle target position based on the motion path stored in the path storage unit 414. In operation S72, the control unit 415 calculates the cycle target angles of the joints 31, 32, 33, 34, 35, 36 described above. In operation S73, the control unit 415 acquires the current angles (feedback values of angles) of the joints 31, 32, 33, 34, 35, 36. In operation S74, the control unit 415 supplies drive power to the actuators 41, 42, 43, 44, 45, 46 so as to reduce the deviation between the cycle target angles and the current angles. In operation S75, the control unit 415 waits for the control cycle to elapse from the start of operation S71. Thereafter, the local controller 400B returns the processing to operation S71. As long as control of the robot 5B is continued, the local controller 400B repeats the above procedure.

### (Motion Path Generation Procedure)

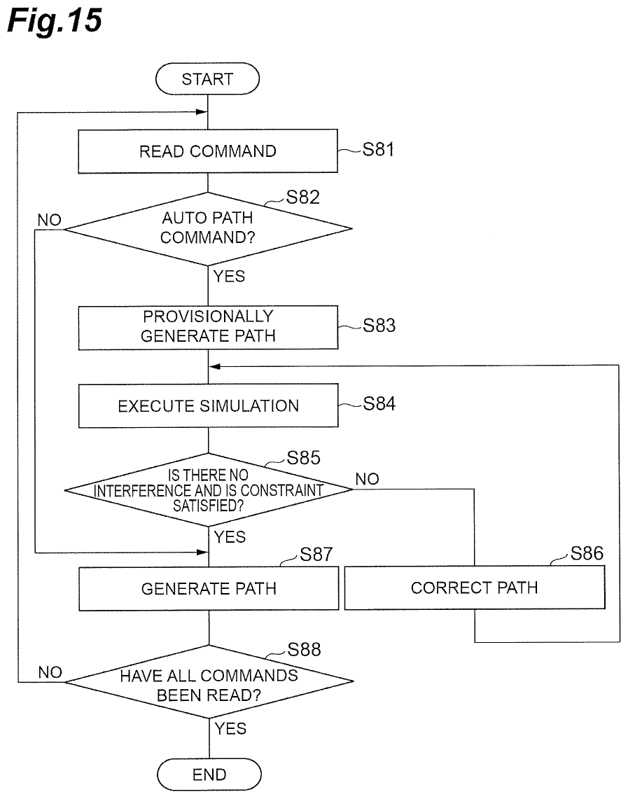

The motion path generation procedure is executed while the control procedure of FIG. 14 is continuing. As illustrated in FIG. 15, the local controller 400B executes operations S81 and S82. In operation S81, the path generation unit 413 reads out an operation command of the task program stored in the program storage unit 411. In operation S82, the path generation unit 413 confirms whether or not the operation command is an auto path command.

In operation S82, when it is determined that the operation command is an auto path command, the local controller 400B executes operations S83, S84, and S85. In operation S83, the path generation unit 413 provisionally generates a motion path from the movement start position and movement start posture to the target position and target posture. In operation S84, the path generation unit 413 requests the local simulator 418 to perform simulation with the provisionally generated motion path. The local simulator 418 operates the model of the robot 5B in virtual space along the provisionally generated motion path. In operation S85, the interference determination unit 432 confirms whether or not the provisionally generated motion path of the robot 5B interferes with surrounding objects of the robot 5B. Furthermore, the interference determination unit 432 confirms whether or not the provisionally generated motion path of the robot 5B satisfies the constraint stored in the condition storage unit 435.

In operation S85, when it is determined that at least one of a condition that the motion path does not interfere with surrounding objects of the robot 5B and a condition that the motion path of the robot 5B satisfies the constraint is not satisfied, the local controller 400B executes operation S86. In operation S86, the path generation unit 413 corrects the motion path. For example, the path generation unit 413 corrects the motion path by adding a waypoint that avoids interference with surrounding objects and satisfies the constraint. Thereafter, the local controller 400B returns the processing to operation S84. Thereafter, the path generation unit 413 repeats correcting the motion path based on the simulation result by the local simulator 418 until both the condition that the motion path does not interfere with surrounding objects of the robot 5B and the condition that the motion path of the robot 5B satisfies the constraint are satisfied.

In operation S85, when it is determined that both the condition that the motion path does not interfere with surrounding objects of the robot 5B and the condition that the motion path of the robot 5B satisfies the constraint are satisfied, the local controller 400B executes operation S87. In operation S87, the path generation unit 413 generates the corrected motion path as a motion path corresponding to the auto path, and stores it in the path storage unit 414.

Next, the local controller 400 executes operation S88. In operation S88, the path generation unit 413 confirms whether or not all operation commands of the task program have been read out. In operation S88, when it is determined that operation commands that have not been read out remain, the local controller 400 returns the processing to operation S81. In operation S88, when it is determined that no operation commands that have not been read out remain, the local controller 400 completes the motion path generation procedure.

### (Interference Check Procedure)

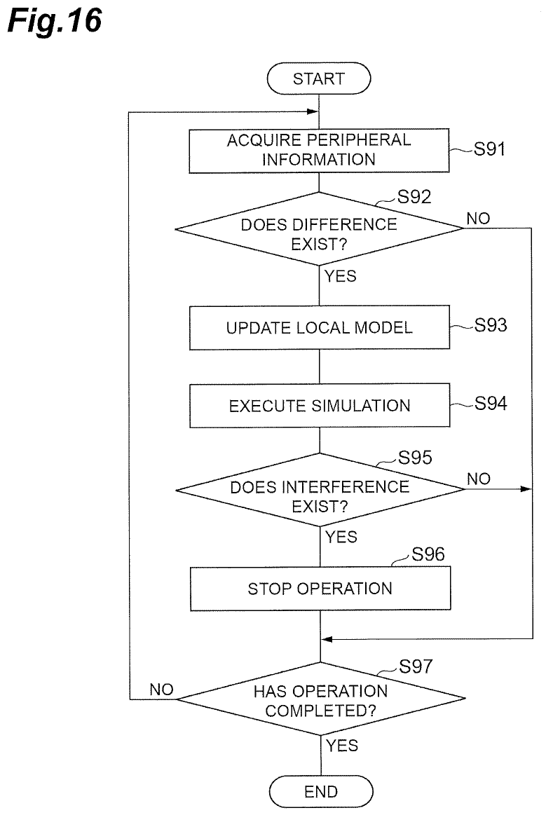

The interference check procedure is executed while the control procedure of FIG. 14 is continuing. As illustrated in FIG. 16, the local controller 400 executes operations S91 and S92. In operation S91, the local model update unit 431 causes the peripheral information acquisition unit 421 to acquire state information of the surrounding environment of the robot 5B. In operation S92, the local model update unit 431 confirms whether or not there is a difference between the space represented by the state information of the robot 5B and the state information of the surrounding environment of the robot 5B acquired by the peripheral information acquisition unit 421 and the space represented by the local model.

In operation S92, when it is determined that there is a difference, the local controller 400 executes operations S93, S94, and S95. In operation S93, the local model update unit 431 reflects the difference in the local model. In operation S94, the local simulator 418 operates the model of the robot 5B in virtual space along the motion path stored in the path storage unit 414 in response to a request from the interference determination unit 432. In operation S95, the interference determination unit 432 confirms whether or not the model of the robot 5B interferes with the model of surrounding objects of the robot 5B, based on the simulation result by the local simulator 418.

In operation S95, when it is determined that the model of the robot 5B interferes with the model of surrounding objects of the robot 5B, the local controller 400 executes operation S96. In operation S96, the control unit 415 stops the operation of the robot 5B. Next, the local controller 400 executes operation S97. In operation S95, when it is determined that the model of the robot 5B does not interfere with the model of surrounding objects of the robot 5B, the local controller 400 executes operation S97 without executing operation S96. In operation S92, when it is determined that there is no difference, the local controller 400 executes operation S97 without executing operations S93 to S96. In operation S97, the interference determination unit 432 confirms whether or not the operation of the robot 5B has been completed. In operation S97, when it is determined that the operation of the robot 5B has not been completed, the local controller 400 returns the processing to operation S91. In operation S97, when it is determined that the operation of the robot 5B has been completed, the local controller 400 completes the interference check procedure.

The above disclosure includes the following configurations.
(1) A control system 3 comprising: a plurality of local controllers 400 configured to respectively control a plurality of machines 5 including a robot 5B; a local simulator 418 configured to simulate, based on a local model including a model of the robot 5B and a model of a surrounding environment of the robot 5B, an operation that the local controller 400 corresponding to the robot 5B causes the robot 5B to perform; and a system simulator 114 configured to simulate, based on a system model including models of the plurality of machines 5 and a model of a surrounding environment of the plurality of machines 5, an operation that the plurality of local controllers 400 cause the plurality of machines 5 to perform.
With the system simulator 114, both the operation of individual machines 5 and the combination of operations of the plurality of machines 5 can be simulated. However, if all simulations for all objectives are performed by the system simulator 114, the computational load may become excessive. For example, the operation of one robot 5B can be verified by simulation based on a model of the robot 5B and a model of the surrounding environment of the robot 5B. Accordingly, by including both the system simulator 114 and the local simulator 418, the system simulator 114 and the local simulator 418 can be selectively used depending on the objective, and the computational load can be suppressed. In addition, with the local simulator 418, which can execute simulation with a smaller computational load compared to the system simulator 114, simulation can be used for applications requiring higher-speed computation, applications requiring higher synchronization, and the like. For example, the local simulator 418 can be implemented near the local controller 400 (for example, inside the local controller 400), and the simulation result by the local simulator 418 can be reflected in real time in the control of the robot 5B by the local controller 400. Therefore, simulation can be utilized more beneficially.
(2) The control system 3 according to (1), further comprising a local model generation unit 120 configured to generate the local model based on the system model.
Since the local model is generated by the system, usability is improved.
(3) The control system 3 according to (2), wherein the local model generation unit 120 is configured to generate the local model by extracting a part of the system model.
Since the computational load on the local simulator 418 is reduced, simulation can be used for applications requiring higher-speed computation.
(4) The control system 3 according to (3), wherein the local model generation unit 120 comprises a range determination unit 121 configured to determine, based on the system model, a range to be extracted as the local model, and the local model generation unit 120 is configured to generate the local model by extracting the range determined by the range determination unit 121.
Based on the system model, the range for the local model can be extracted without excess or deficiency.
(5) The control system 3 according to any one of (2) to (4), wherein the local model generation unit 120 is configured to generate the local model by performing a predetermined data conversion on the system model.
Even when the data formats of the local model and the system model are different, the local model can be readily generated based on the system model.
(6) The control system 3 according to (2), wherein the local model generation unit 120 comprises: a range determination unit 121 configured to determine, based on the system model, a range to be extracted as the local model; and a model converter 122 configured to generate the local model by performing a predetermined data conversion on the determined range.
Even when both the range and the data format are different between the local model and the system model, the local model can be readily generated based on the system model. In addition, since data conversion is performed on the range to be extracted, the computational load for generating the local model can be reduced compared to performing data conversion on the entire system model.
(7) The control system 3 according to any one of (1) to (6), further comprising: a local model correction unit 422 configured to correct the local model based on state information of the robot 5B and the surrounding environment of the robot 5B; and a system model correction unit 131 configured to correct the system model based on a correction to the local model made by the local model correction unit 422.
Both the local model and the system model can be readily adapted to the actual situation.
Therefore, simulation can be utilized more beneficially.
(8) The control system 3 according to any one of (1) to (7), further comprising a system model generation unit 132 configured to generate the system model based on information acquired from the plurality of local controllers 400.
By aggregating information from the plurality of local controllers 400, the system model can be readily generated.
(9) The control system 3 according to any one of (1) to (8), wherein the local controller 400 comprises: a path generation unit 413 configured to generate a motion path of the robot 5B based on a simulation result of the local simulator 418, while control of the plurality of machines 5 by the plurality of local controllers 400 is at least partially ongoing; and a control unit 415 configured to operate the robot 5B along the motion path.
With the local simulator 418, simulation can be used during control.
(10) The control system 3 according to any one of (1) to (9), further comprising a local model update unit 431 configured to update the local model based on a change in the surrounding environment of the robot 5B, wherein the local controller 400 comprises an interference determination unit 432 configured to determine, based on a simulation result of the local simulator 418 based on the updated local model, whether a motion path of the robot 5B interferes with a surrounding object of the robot 5B.
The robot 5B can be operated while verifying in real time whether or not a predetermined motion path of the robot 5B can adapt to changes in the surrounding environment.
(11) The control system 3 according to any one of (1) to (10), wherein the local controller 400 is configured to control the robot 5B based on a simulation result of the system simulator 114 and a simulation result of the local simulator 418.
By using both the system simulator 114 and the local simulator 418, the autonomy of the robot 5B can be enhanced, and the burden on workers such as system integrators can be reduced.
(12) The control system 3 according to (11), further comprising a task identification unit 315 configured to identify a task to be performed by the robot 5B, based on the simulation result of the system simulator 114, wherein the local controller 400 is configured to control, based on the simulation result of the local simulator 418, the robot 5B to perform the task.
By utilizing simulation for both task identification and task execution, the autonomy of the robot 5B can be enhanced.
(13) The control system 3 according to (12), wherein the local controller 400 comprises a path generation unit 413 configured to generate a motion path of the robot 5B for performing the task, based on the simulation result of the local simulator 418, and the local controller 400 is configured to operate the robot 5B along the motion path generated by the path generation unit 413.
By utilizing simulation for both task identification and generation of a motion path for executing the task, the autonomy of the robot 5B can be enhanced.
(14) The control system 3 according to (12) or (13), wherein the local controller 400 comprises an interference determination unit 432 configured to determine, based on the simulation result of the local simulator 418, whether a motion path of the robot 5B to perform the task interferes with a surrounding object of the robot 5B, and the local controller 400 is configured to operate the robot 5B to perform the task when the interference determination unit 432 determines that the motion path does not interfere with the surrounding object.
By utilizing simulation for both task identification and interference checking, both autonomy and reliability can be achieved.
(15) The control system 3 according to any one of (11) to (14), further comprising a condition generation unit 117 configured to generate a constraint for an operation of the robot 5B, based on the simulation result of the system simulator 114, wherein the local controller 400 is configured to control the robot 5B based on the constraint and the simulation result of the local simulator 418.
By utilizing simulation for both generation of a constraint and control based on the constraint, the autonomy of the robot 5B can be enhanced.
(16) The control system 3 according to (15), wherein the local controller 400 comprises a path generation unit 413 configured to generate a motion path of the robot 5B so as to satisfy the constraint, based on the simulation result of the local simulator 418, and the local controller 400 is configured to operate the robot 5B along the motion path generated by the path generation unit 413.
By utilizing simulation for both generation of a constraint and generation of a motion path satisfying the constraint, the autonomy of the robot 5B can be enhanced.
(17) A control method, comprising: simulating, based on a system model including models of a plurality of machines 5 and a model of a surrounding environment of the plurality of machines 5, an operation that a plurality of local controllers 400 cause the plurality of machines 5 to perform; simulating, based on a local model including a model of a robot 5B included in the plurality of machines 5 and a model of a surrounding environment of the robot 5B, an operation that a local controller 400 corresponding to the robot 5B causes the robot 5B to perform; and controlling the robot 5B based on a simulation result from the system model and a simulation result from the local model.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A control system comprising:
a plurality of local controllers configured to respectively control a plurality of machines including a robot;
a local simulator configured to simulate, based on a local model including a model of the robot and a model of a surrounding environment of the robot, an operation that a local controller corresponding to the robot causes the robot to perform; and
a system simulator configured to simulate, based on a system model including models of the plurality of machines and a model of a surrounding environment of the plurality of machines, an operation that the plurality of local controllers cause the machines to perform.

2. The control system according to claim 1, further comprising circuitry configured to generate the local model based on the system model.

3. The control system according to claim 2, wherein the circuitry is configured to generate the local model by extracting a part of the system model.

4. The control system according to claim 3, wherein the circuitry is configured to:
determine, based on the system model, a range to be extracted as the local model; and
generate the local model by extracting the determined range from the system model.

5. The control system according to claim 2, wherein the circuitry is configured to generate the local model by performing a predetermined data conversion on the system model.

6. The control system according to claim 2, wherein the circuitry is configured to:
determine, based on the system model, a range to be extracted as the local model; and
generate the local model by performing a predetermined data conversion on the determined range of the system model.

7. The control system according to claim 1, further comprising circuitry configured to:
correct the local model based on state information of the robot and the surrounding environment of the robot; and
correct the system model based on a correction to the corrected local model.

8. The control system according to claim 1, further comprising circuitry configured to generate the system model based on information acquired from the plurality of local controllers.

9. The control system according to claim 1, wherein the local controller is configured to:
generate a motion path of the robot based on a simulation result of the local simulator, while control of the plurality of machines by the plurality of local controllers is at least partially ongoing; and
operate the robot along the motion path.

10. The control system according to claim 1, further comprising circuitry configured to update the local model based on a change in the surrounding environment of the robot,
wherein the local controller is configured to determine, based on a simulation result of the local simulator based on the updated local model, whether a motion path of the robot interferes with a surrounding object of the robot.

11. The control system according to claim 1, wherein the local controller is configured to control the robot based on a simulation result of the system simulator and a simulation result of the local simulator.

12. The control system according to claim 11, further comprising circuitry configured to identify a task to be performed by the robot, based on the simulation result of the system simulator,
wherein the local controller is configured to control, based on the simulation result of the local simulator, the robot to perform the task.

13. The control system according to claim 12, wherein the local controller is configured to:
generate a motion path of the robot for performing the task, based on the simulation result of the local simulator, and
operate the robot along the generated motion path.

14. The control system according to claim 12, wherein the local controller is configured to:
determine, based on the simulation result of the local simulator, whether a motion path of the robot to perform the task interferes with a surrounding object of the robot; and
operate the robot to perform the task in response to determining that the motion path does not interfere with the surrounding object.

15. The control system according to claim 11, further comprising circuitry configured to generate a constraint for an operation of the robot, based on the simulation result of the system simulator,
wherein the local controller is configured to control the robot based on the constraint and the simulation result of the local simulator.

16. The control system according to claim 15, wherein the local controller is configured to:
generate a motion path of the robot so as to satisfy the constraint, based on the simulation result of the local simulator; and
operate the robot along the generated motion path.

17. A control method, comprising:
simulating, based on a system model including models of a plurality of machines and a model of a surrounding environment of the plurality of machines, an operation that a plurality of local controllers cause the plurality of machines to perform;
simulating, based on a local model including a model of a robot included in the plurality of machines and a model of a surrounding environment of the robot, an operation that a local controller corresponding to the robot causes the robot to perform; and
controlling the robot based on a simulation result from the system model and a simulation result from the local model.

18. The control method according to claim 17, further comprising generating the local model based on the system model.

19. The control method according to claim 18, wherein said generating the local model comprises generating the local model by extracting a part of the system model.

20. The control method according to claim 19, wherein said generating the local model comprises:
determining, based on the system model, a range to be extracted as the local model; and
generating the local model by extracting the determined range of the system model.
